(19) United States
(12) Patent Application Publication
(10) Pub. No.: US 2019/0221913 A1
(43) Pub. Date: Jul. 18, 2019

(54) SMALL MODULAR CELL POLE

(71) Applicant: COMPTEK TECHNOLOGIES, LLC, Boulder, CO (US)

(72) Inventor: DANA ANTHONY CASTRONOVA, WESTMINSTER, CO (US)

(21) Appl. No.: 16/249,690

(22) Filed: Jan. 16, 2019

Related U.S. Application Data
(60) Provisional application No. 62/617,960, filed on Jan. 16, 2018.

(51) Int. Cl. H01Q 1/12; H01Q 1/24; H04W 88/10

(52) U.S. Cl. CPC H01Q 1/1242; H04W 88/10; H01Q 1/246

(57) ABSTRACT

The present disclosure is directed to small cell poles. In various implementations, the small cell poles have a configuration similar to existing utility poles, which minimizes their aesthetic obtrusiveness. To accommodate multiple wireless service provides at a single location, the small cell poles are modular. The cell pole has a base structure that includes two or more equipment housings that are vertically stacked. The equipment housings house cell control equipment of different wireless providers. Additional housings may be added as needed. A pole extends from the upper housing to an antenna support structure that supports two or more antennas of the different wireless providers. The support structure is modular such that additional antennas may be added as needed.

### CROSS REFERENCE

The present application claims the benefit of the filing date of U.S. Provisional Application No. 62/617,960 filed on Jan. 16, 2018, the entire contents of which is incorporated herein by reference.

### FIELD

The present disclosure is directed to cell poles for providing coverage for local service areas. More specifically, the present disclosure is directed to small cell poles configured to house equipment and support antennas of multiple wireless providers.

### BACKGROUND

In wireless communication networks, high powered base stations (e.g., towers supporting antennas) commonly provide serve service to wireless user devices. Each base station is capable of serving wireless user devices in a coverage area that is primarily determined by the power of the signal it can transmit. Frequently, high powered base stations are located in a grid pattern and these base stations typically mount various antennas at an elevated location, such as on a tower. For example, such base stations may include a single omnidirectional antenna, two 90 degree sector antennas, or three 120 degree sector antennas to provide 360 degree coverage. In any arrangement, radio wave propagation from the base station is affected in unpredictable ways by objects in the environment, such as trees, buildings and so forth. Radio signals will often follow the roadways in urban canyons, bouncing back and forth between buildings, and not following a direct line between the emitter and receiver. Such interference affects the data transfer rate of such large base stations.

To improve wireless access, providers are moving toward smaller stations that provide coverage for a more limited geography. That is, to augment the coverage of the wireless network, wireless transceiver devices/stations (e.g., antennas) with relatively small coverage areas (and serving capacities) are deployed. Depending on their coverage area and serving capacities, these wireless transceiver devices are referred to as “femto” cells or “pico” cells, or more generally, small cell access point devices or small cell poles. For simplicity and generality, the term “small cell pole” is used herein to refer to a wireless transceiver device that is configured to serve wireless user devices over relatively small coverage areas and with generally less capacity as compared to a “macro” base station that is configured to serve a relatively large coverage area (“macro cell”). Such small cell poles are now being deployed to provide coverage for individual city blocks. Along these lines, such small cell poles are commonly deployed on sidewalks and other rights-of-way within urban environments.

The ever increasing use of RF bandwidth or ‘mobile data’ requires a corresponding increase in the number of small cell poles located within urban environments. By way of example, proposed 5G wireless networks promise greatly improved network speeds and are currently being planned and implemented. However, such networks typically require shorter RF transmission distances compared to existing networks and will require more dense networks of access points/small cell poles to handle data traffic. In the wireless industry, this is referred to as densification. Residents of many communities have objected to such densification in their neighborhoods often due to the aesthetic concerns of such small cell poles.

### SUMMARY

The present disclosure is directed to small cell poles that are configured for use primarily, though not exclusively, in urban environments. In various implementations, the small cell poles have configurations similar to existing utility poles, which minimizes their aesthetic obtrusiveness. To reduce the densification of cell structures with an urban environment, the disclosed small cell poles are configured to separately house two or more sets of cell control equipment and support two or more sets of antennas. Such an arrangement permits a small cell access point to support the equipment of two or more wireless providers thereby reducing the amount of cell structures in an urban environment.

The small cell poles each include a base or lower housing and at least one upper housing. Typically, the housings are stacked in a vertical orientation. The housings each include top and bottom surfaces and a sidewall that extends between these surfaces. The sidewall defines an interior space of the housing. The interior space of the housings may be used to house various components associated with the cell pole. In an arrangement, the lower housing houses a first set of antenna control equipment/cell control equipment (e.g., of a first wireless provider) and the upper house houses a second set of cell control equipment (e.g., of a second wireless provider). A pole is attached to and supported by the upper housing. An upper end of the pole supports an antenna structure. In an arrangement, the antenna structure includes first and second antennas or first and second sets of antennas. In an arrangement, the first antenna and the first set of cell control equipment are operatively connected by one or more cables (e.g., communication cables, power cables, etc.) and the second antenna and the second set of cell control equipment are operatively connected by one or more cables. In a particular arrangement, the cables are routed through the interior(s) of the housings and an interior of the pole. If needed for a particular location, additional housings and/or antennas may be added to the small cell pole. That is, the housings are modular and additional housing may be stacked on the base housing.

The use of separate housings provides different users (e.g., wireless providers) with separately accessible housings to house their equipment. Along these lines, each housing may include various access panels and/or doors that permit access to the interior spaces of the housings. Such doors may include latches and/or locks to limit access to a particular user.

In an arrangement, the antenna structure includes two or more modular antenna support sections. A first antenna support section is connectable to the top end of the pole. The first antenna support section is an elongated member having an upper end and a lower end that are spaced to define an interior volume there between. At least the first support structure extends between the upper end and lower end. The antenna support section may house one or more antennas within its interior volume. A second antenna support section may be connected to the first support structure. The second antenna support section may be configured similarly to the first antenna support section such that the second antenna support section is supported by the first antenna support section. Additional antenna support sections may be incorporated above the second antenna support section. In this regard, the antenna support sections are modular sections allowing additional antenna support sections to be added depending on needs of particular small cell pole. In various implementations, a radio-frequency transparent sleeve is applied around the antenna support sections.

In one implementation, the antenna support sections are formed of annular end plates, which need not be circular (e.g., octagonal). The annular end plates include an interior aperture that permits the passage of cables through the antenna support sections. In one arrangement, the annular in plates include a plurality of apertures around their periphery to allow for connection to the pole, adjacent antenna support section or other structures. The plurality of apertures permit adjacent antenna support sections to be rotated relative to one another such that supported antennas may be directed in different directions. In one implementation, the apertures are elongated to permit additional directional adjustment of antennas supported by the antenna support sections.

### BRIEF DESCRIPTION OF THE DRAWINGS

FIG. 1 illustrates one embodiment of a small cell pole.

FIG. 2 illustrates one embodiment of an equipment housing.

FIG. 3 illustrates one embodiment of equipment that may be disposed at least partially within the interior of an equipment housing.

FIG. 4A illustrates one embodiment of a modular small cell pole.

FIG. 4B Illustrates the base equipment housing and an upper equipment housing of the modular small cell pole of FIG. 4A.

FIG. 5 illustrates an exploded view of a modular small cell pole having three equipment housings.

FIGS. 6A and 6B illustrate one embodiment of modular antenna sections.

FIGS. 7A and 7B illustrate another embodiment of modular antenna sections.

### DETAILED DESCRIPTION

Reference will now be made to the accompanying drawings, which at least assist in illustrating the various pertinent features of the presented inventions. The following description is presented for purposes of illustration and description and is not intended to limit the inventions to the forms disclosed herein. Consequently, variations and modifications commensurate with the following teachings, and skill and knowledge of the relevant art, are within the scope of the presented inventions. The embodiments described herein are further intended to explain the best modes known of practicing the inventions and to enable others skilled in the art to utilize the inventions as presented or various modifications required by the particular application(s) or use(s).

The present disclosure is directed to small cell poles that are configured for use primarily in urban environments. That is, in various embodiments the small cell poles have a configurations that minimizes their aesthetic obtrusiveness making them more suited for use in urban environments. Various embodiments of the presented inventions are related to the recognition by the inventors that small cell poles may be incorporated into configurations that are similar to utility poles currently existing in urban environments. By way of example, most streets already have a number of light poles and/or power poles. Accordingly, by mimicking the configuration of such existing poles, the obtrusiveness of such small cell poles may be reduced. Further, the inventors have recognized that it would be desirable for a small cell pole to support the wireless equipment (e.g., antenna/cell control equipment and antennas) of two or more wireless service providers to reduce the densification of cell equipment in urban environments. Yet further, the inventors have recognized that by making the small cell pole a modular structure, a single location (e.g., access point) may be easily modified to accommodate multiple service providers at that single location.

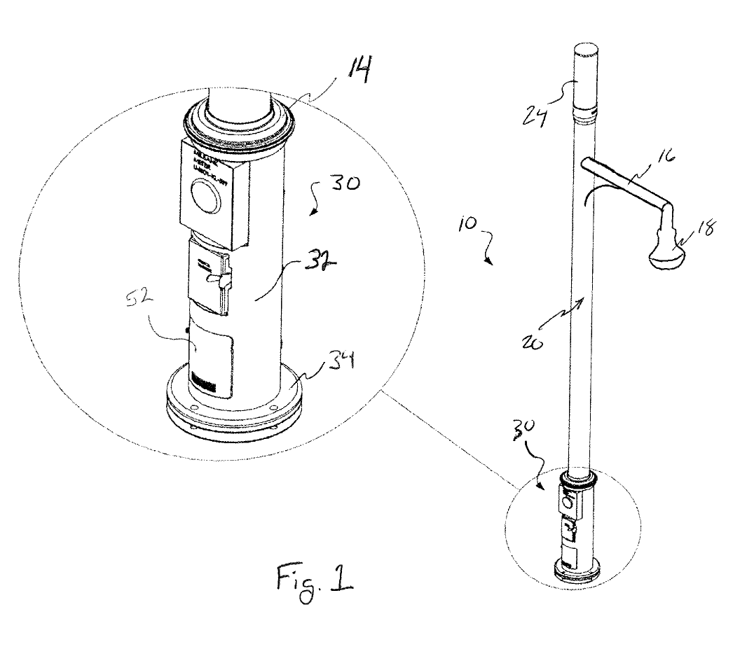

FIG. 1 illustrates one embodiment of a small cell pole 10. Various features of this small cell pole are disclosed in co-owned U.S. Patent Publication No. 2017/0279187, the entire contents of which is incorporated herein by reference. As shown, the cell pole includes a lower equipment housing 30 (e.g., base housing) that includes an inner cavity (e.g., interior space) configured to house various equipment (e.g., cell control equipment). A mono pole 20 is attached to an upper surface of the equipment housing 30. An upper end of the mono pole 20 supports one or more antenna housings/structures 24. As shown, the cell pole 10 has a two-part design: the lower equipment housing 30 and the mono pole 20. The two-part construction allows for easier construction and implementation during set-up. That is, the equipment housing 30 can be installed separately from the mono pole 20 and/or antenna structure 24. Additionally, any equipment contained in the equipment housing may be installed at a later time. The present embodiment also illustrates an optional light mast or arm 16 attached to an upper portion of the mono pole 20. The illustrated light mast 16 supports a street light 18.

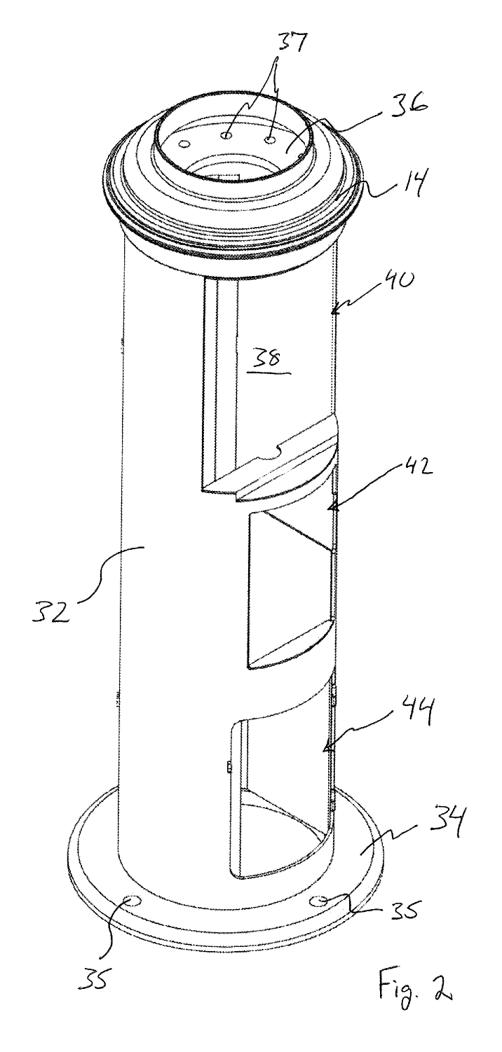

As shown in FIG. 2, the illustrated embodiment of equipment housing 30 has a generally cylindrical sidewall 32 that extends between a lower flange 34 and an upper flange 36. The generally cylindrical sidewall 32 defines an interior 38 (e.g., enclosed interior space) of the equipment housing 30. The lower flange 34 includes a plurality of apertures 35 (e.g., bolt holes) used to mount the housing 30 to a surface (e.g., ground, sidewalk, etc.). Other installation methods are possible. Typically, the lower flange 34 is an annular element with an open interior. The open interior of the lower flange allows routing various connections (e.g., electrical power, telecommunication lines, etc.) into the bottom of the housing 30. The upper flange 36 is likewise an annular element with an open interior. The upper flange 36 also includes a plurality of apertures 37 (e.g., bolt holes). Fasteners, such as bolts, may extend through the apertures 37 to attach the mono pole 20 to the top of the housing 30. The hollow interior of the equipment housing 30 may open into a generally hollow interior of the mono pole 20. This allows passage of cables from the equipment housing 30 through the open interior of the upper flange 36 into the interior of the mono pole 20 and to, for example, one or more antennas, lights or other devices (e.g., sensors) supported by the pole.

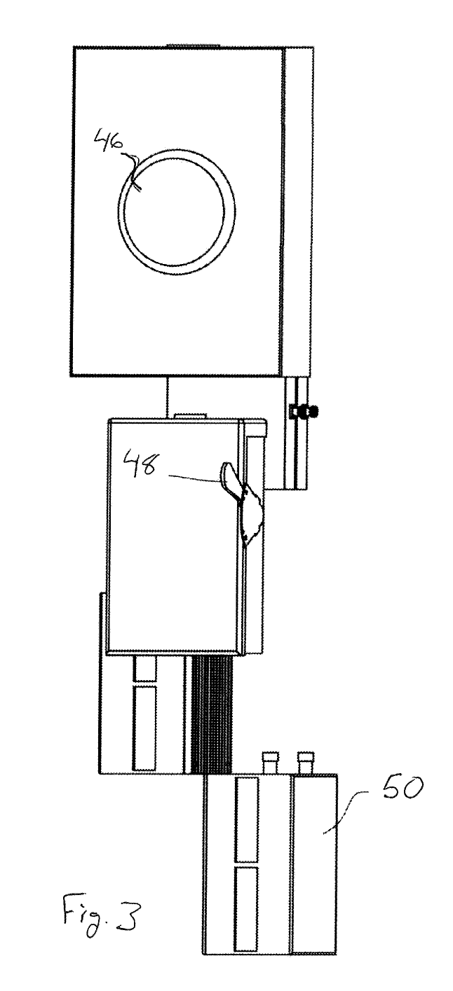

In the illustrated embodiment, the equipment housing 30 includes three access openings 40, 42 and 44 defined in the forward surface of the sidewall 32. However, it will be appreciated that the number and configuration of the access openings may vary. FIGS. 1 and 3 illustrate exemplary equipment that may be disposed within the interior 38 of the equipment housing 30. In the illustrated embodiment, the equipment includes an electric meter 46, a switch 48, and cell control equipment 50. In the present embodiment, the meter 46 and switch 48 are disposed in the upper and middle openings 40, 42, respectively, and these devices are at least partially exposed. Further, in this embodiment, the cell control equipment 50 is disposed within the interior of the housing behind the lower opening 44. In the present embodiment, a door 52 covers the lower opening 44 to limit access to the control equipment 50 to authorized personnel. See FIG. 1. The door 52 may include various latching and/or locking mechanisms (not shown). When housing cell control equipment, cabling (not shown) may extend from the interior of the housing 30, through the mono pole 20 to the antenna structure 24. It will be appreciated that the interior of the equipment housing 30 may include any appropriate type of equipment including, but not limited to, sensors, switches, batteries, processors, memory, dash boards, displays, other types of equipment, or combinations thereof. Further, each of the access openings may include doors that may be mounted to the equipment housing to enclose equipment from the elements while providing selective access, when desired, to modify, regulate, change out, or otherwise access the equipment. The housing may include locks, hinges, access doors, vents for passive radiant cooling, and/or viewing ports. Cable ports and other features may be formed therein during manufacture.

As shown in FIGS. 1 and 2, a decorative shroud 14 is disposed on an upper end of the equipment housing 30. The shroud generally covers the interface between the housing 30 and the mono pole 20. The shroud 14 also directs water away from the interior of the housing. The configuration of the shroud may be varied to aid in assimilating the small cell pole with its urban surroundings. That is, the shroud provides for the ability to customize the structure to aesthetically fit in with the architectural theme of the location where the pole system is being installed. For instance, the cell pole may simulate the look and feel of a street light pole to better blend with its urban setting.

Generally, the equipment housing 30 is utilized to house and enclose control equipment for a cell access point while the mono pole 20 supports and/or houses one or more antennas. Utilization of the small cell pole is important for urban environments as right-of-way utilized for light poles is typically controlled by the municipalities. Along these lines, a cell provider may have access to locations for cell access points without having to engage multiple individual owners of different properties. That is, an existing light pole may be replaced with the small cell pole, which may incorporate a street light. Accordingly, the system provides desirable means for providing enhanced cell coverage. However, in some instances, multiple cell providers may desire to utilize a common location. In such instances, the ability to house the necessary control equipment of different providers for a cell access point is limited by use of a single equipment housing. Accordingly, it has been recognized that it would be desirable allow for selectively increasing the interior volume of the small cell pole system without necessarily increasing its footprint.

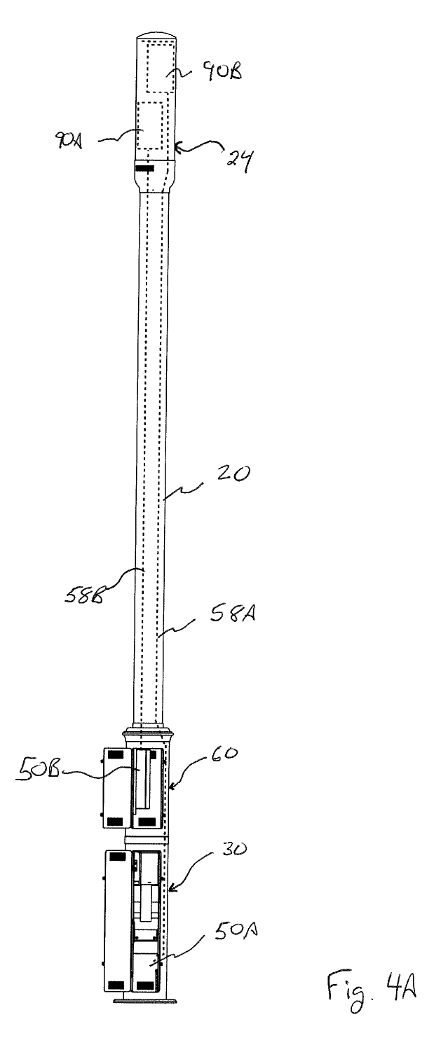

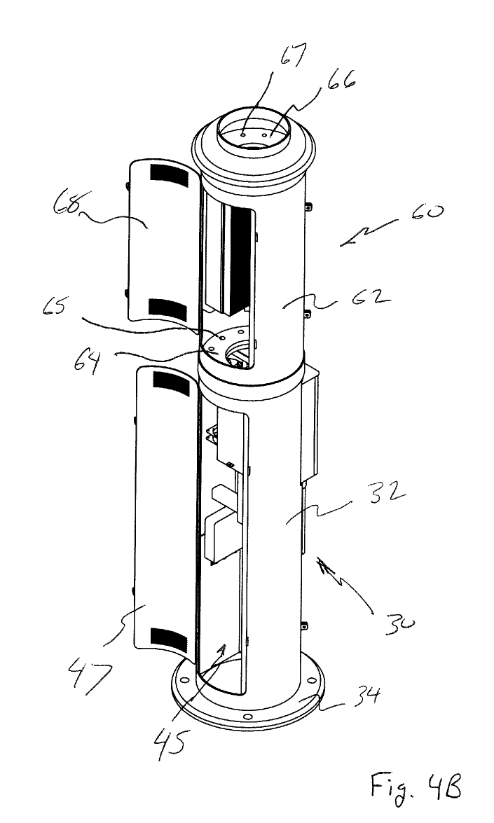

To accommodate multiple providers at a single location, the present disclosure is directed to a modular system where two or more equipment housings are stacked vertically to provide additional interior volume to house equipment for the pole system without increasing the footprint of the system. Such a modular system 100 is illustrated in FIGS. 4A and 4B. As shown, the modular system includes a lower equipment housing 30 (e.g., base housing), an upper equipment housing 60, which is disposed on top of the lower equipment housing 30, a monopole 20, and an antenna structure/housing 24.

FIG. 4B illustrates a rear perspective view of the lower equipment housing 30 and the upper equipment housing 60. As shown, the lower equipment housing 30 is substantially identical to the equipment housing of FIG. 2, with the exception that the rearward surface of the housing is illustrated showing a rearward access opening 45 and door 47. The upper equipment housing 60 is configured similarly to the lower equipment housing. As shown, the upper equipment housing 60 includes a generally cylindrical sidewall 62 that extends between a lower flange 64 and an upper flange 66, which collectively define an interior space of the equipment housing 60. The lower flange 64 includes a plurality of apertures 65 (e.g., bolt holes) used to mount the housing 60 to a lower equipment housing (e.g., housing 30). The upper flange 66 also includes a plurality of apertures 67 (e.g., bolt holes). Fasteners, such as bolts, may extend through the apertures 67 to attach the mono pole 20 to the top of the housing 60 or attach another housing above the upper housing 60. Typically, both flanges 64, 66 are annular elements with an open interiors to permit routing various connections (e.g., electrical power, telecommunication lines, etc.) into and/or through the housing 60. As with the lower housing 30, the upper housing 60 may include one or more openings and doors 68.

The configuration of the upper and lower housings may be varied. For instance, the upper housing may have different dimensions (e.g., height) than the lower housing. Further, the openings may be differently configured between the upper and lower housings. Alternatively, the housings may be identical. In any configuration, the lower housing 30 may contain cell control equipment 50A of a first wireless service provider while the second housing 60 may contain cell control equipment 50B of a second wireless provider. See, e.g., FIG. 4A. In the illustrated embodiment, cabling 58A (e.g., power and communications as illustrated by the dashed line) may pass from the cell control equipment 50A of the first wireless provider through the hollow interior of the lower housing 30, through the hollow interior of the upper housing 60, through the hollow interior of the mono pole 20 and connect to the first provider's antenna 90A in the antenna structure 24. Likewise, cabling 58B may pass from the cell control equipment 50B of the second wireless provider, through the hollow interiors of the upper housing 60 and mono pole to connect to the second provider's antenna 90A. Such providers may have individual access to their respective housing and/or access opening. Of further note, the owner of the small cell pole may lease this space to the different providers thereby enhancing their revenue for a given access point.

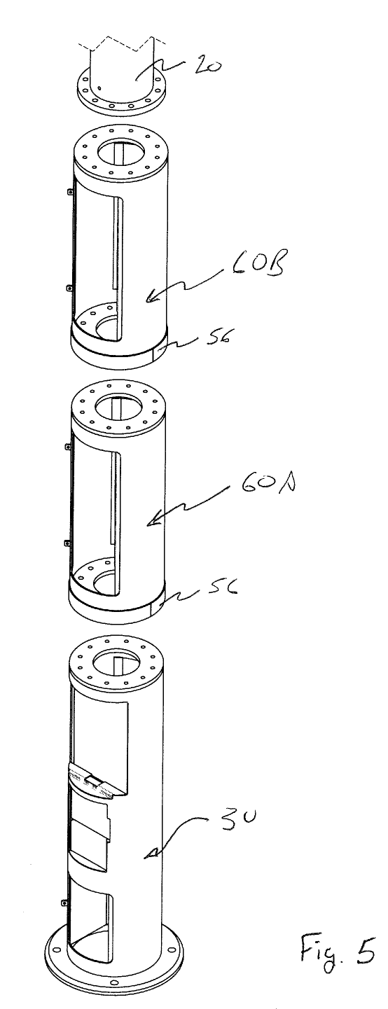

The modular system 100 permits adding and removing housings to accommodate the needs of a given access point/location. FIG. 5 illustrates an exploded perspective view of the modular system 100 including three equipment housings, a base housing 30, a mid-equipment housing 60A, and an upper equipment housing 60B. As shown, the housings 30, 60A and 60B are configured to be attached to one another while the uppermost housing 60A supports the mono pole 20. It will be appreciated, the use of the stacked housings permits the expansion of the interior volume of the pole system without increasing the footprint of the poll system, which may be located on a sidewalk where space is at a premium. In the illustrated embodiment, each of the housings has a common diameter. However, it will be appreciated that this is not a requirement. For instance, each upper housing may have a diameter that is smaller than its lower/supporting housing. Furthermore, each of the housings may be tapered such that the combination of housings taper from the bottom to the top.

If desired, the joints between the modular housings may incorporate an annular flange 56 to hide and/or decorate the joint between adjacent equipment housings when assembled. This is illustrated in FIG. 5 which shows a flange 56 connected to the bottom edge of each of the upper equipment housings 60A and 60B.

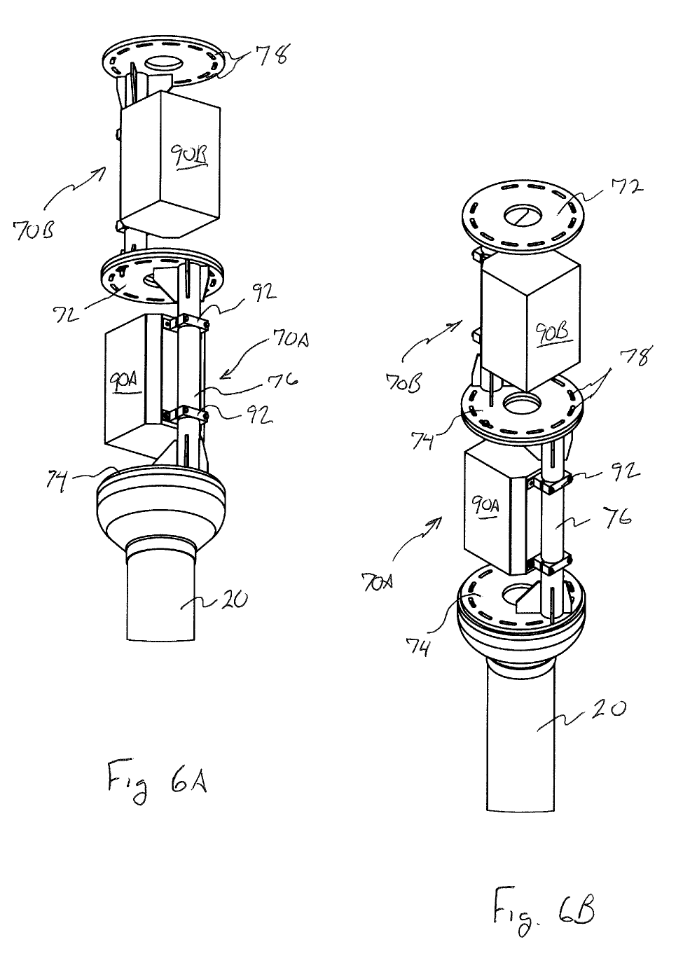

To provide a modular system that accommodates multiple wireless service providers, it is also desirable that the small cell pole system incorporate a modular antenna support structure. FIGS. 6A and 6B illustrates one embodiment of the antenna structure shown in FIGS. 1 and 4A with an outer antenna structure cover or sleeve member removed. Typically, the sleeve member is a thin covering that is substantially transparent to radiofrequency (RF) waves. Such RF transparent materials include, without limitation, fiber glasses, polymers and/or fabrics. As shown in FIGS. 6A and 6B, the antenna structure is attached to the upper end of the mono pole 20. That is, an upper end of the mono pole 20 is connected to and supports one or more modular antenna sections 70A, 70B (hereafter 70 unless specifically referenced). As shown, the upper end of the mono pole 20 supports a lower end of a first modular antenna support section 70A. In the illustrated embodiment, an upper end of the first modular antenna support section 70A is connected to and supports a lower end of the second modular antenna support section 70B. Likewise, the lower end subsequent antenna sections may be supported by the upper end of the antenna section disposed directly below. The use of the modular antenna sections 70 allows the modular system 100 to add additional antenna sections as needed.

For instance, different wireless providers may utilize different support sections for their antennas, which may be connected to cell control equipment disposed within individual equipment housings as discussed above. In the illustrated embodiment, each antenna support section 70 supports a single panel antenna 90A or 90B. However, the exact configuration of the antenna(s) may be varied.

As shown, first and second modular antenna support sections 70A and 70B are sized to be disposed within disposed within a sleeve (not shown) of the antenna housing 24 while stacking first and second antennas 90A and 90B in a vertical orientation. As shown, each antenna support section 70 includes an upper end and a lower end, which are formed as an upper annular plate 72 and a lower annular plate 74, respectively. The two plates 72, 74 each include a central aperture, which permit the extension of wiring or cabling (not shown) through the antenna support section, when the modular cell pole is assembled. As shown the two plates 72, 74 are disposed in a spaced relationship to define an interior volume between the plates. This interior volume is sized to house an antenna therein and permit the sleeve to surround the antenna support section. However, this is not a requirement and the antennas may be exposed. Though shown with two antenna support sections, it will be appreciated that, due to the modular nature of the support sections, additional antenna support sections could be added. In an embodiment, the first antenna support section 70A supports an antenna 90A of a first wireless provider and the second antennal support section 70B supports an antenna 90B of a second wireless provider. Accordingly, the antennas of the provides may be connected via cabling (not sown) to control equipment disposed in the equipment housing of that particular provider.

In the illustrated embodiment, a structural support or strut 76 extends between the upper plate 72 and lower plate 74. The ends of the strut 76 are fixedly attached (e.g., welded, bolted, integrally formed, etc.) to each plate. As will be appreciated, when utilized in the assembled cell pole, the antenna support section 70 becomes a structural member that supports structures attached to its upper end such as, for example, upper antenna support section, lights etc. Thus, the antenna support section must support loads such as compressive loads and/or moment loads (e.g., wind loading) applied by supported structures or elements. Accordingly, the strut 76 may include multiple struts (not shown) that extend between the plates and/or various bracing with the plates to provide adequate structural rigidity. Further, it will be noted that when multiple antenna support sections are provided in a single cell pole, the configuration of adjacent antenna support sections may be different. For instance, a lower antenna support section may have thicker plates and/or struts (e.g., to support greater loads) while upper antenna support sections may have thinner plates and/or struts and/or be made of different materials. For instance, the lower antenna support section may be made of steel while upper antenna support sections may be made of a lighter materials such as aluminum or composites.

As shown in the illustrated embodiment, the structural support or strut 76 is offset from the center or longitudinal axis of the antenna support section 70 to increase the interior volume of the antenna support section 70. However, this is not a requirement. In the illustrated embodiment, the strut 76 also forms an antenna mount, though separate antenna mounts are possible and considered within the scope of the present disclosure. As shown in FIGS. 6A and 6B, the antennas have rearward brackets 92 that are configured to mount about the strut 76, which in the present embodiment is a substantially cylindrical element. These brackets 92 may be tightened around the strut 76 when the antenna 90 is in a desired position. This allows for fine-tuning the directionality of the antenna.

To further permit fine directing of antennas supported by the illustrated antenna support section 70, the upper and lower plates 72, 74 each include a plurality of apertures 78 disposed about their periphery. These apertures 78 allow for connecting each antenna support section 70 to structures above and below the antenna support section 70 utilizing one or more fasteners (e.g., bolts). The apertures 78 allow for rotating each antenna support section relative to one or more adjacent antenna support sections to align two or more adjacent antennas in different azimuth directions. Further, the apertures 78 may be elongated. The elongation of the apertures 78 permits additional adjustment between two adjacent structures prior to affixing their relative positions, for example, by tightening one or more fasteners. Accordingly, this additional adjustment provides fine-tuning of the direction of an antenna supported by the antenna support section 70.

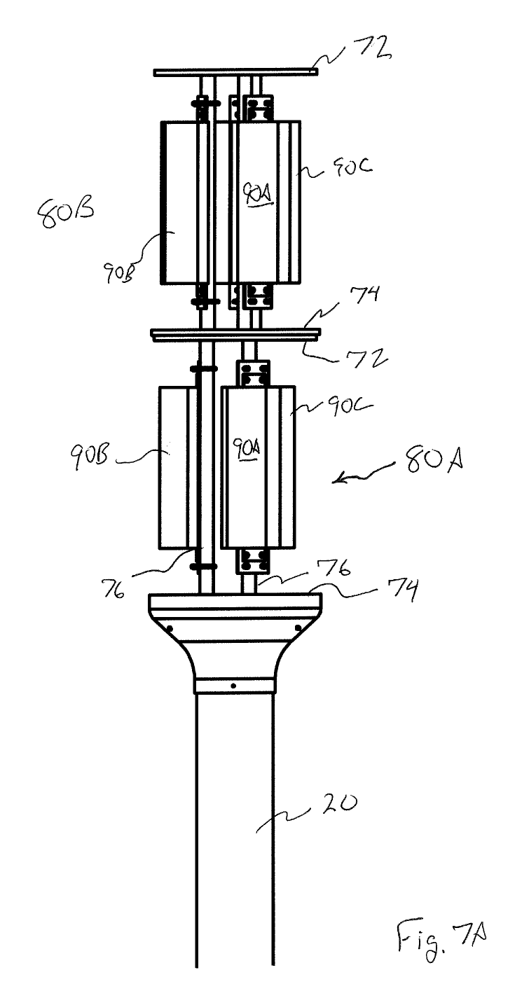

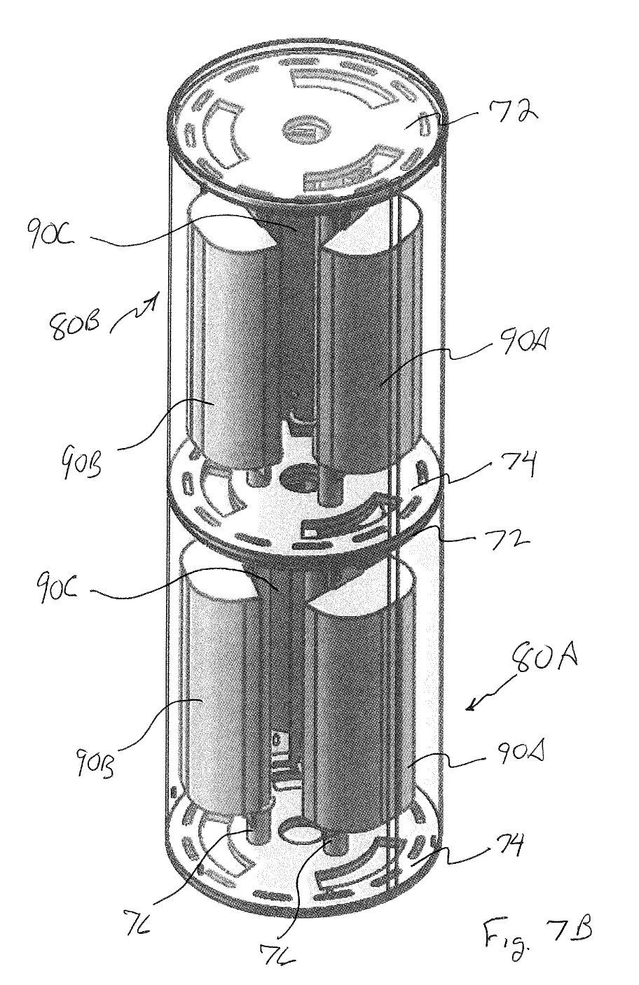

FIGS. 7A and 7B illustrate an alternate modular antenna support structure. As shown, this embodiment illustrates two antenna support sections 80A and 80B that each support three antennas 90A, 90B and 90C (e.g., sector antennas) that provide coverage for different arc portions or azimuth directions of a 360° coverage cell. This embodiment also utilizes first and second spaced plates 72, 74. However, in this embodiment, three struts 76 extend between each pair of plates. Each of the struts supports an individual sector antenna. As shown, the struts are disposed around the central apertures of the plates. This provides location through which cabling and/or wiring may be routed to facilitate assembly of the antenna structure. As above, the modular configuration allows two or more different wireless providers to share a common cell pole. For example, a first wireless provider may utilize the first antenna support structure 90A while a second wireless provider may utilize the second antenna support structure 90B. Likewise, a third wireless provider could use a third antenna support structure. Such an arrangement may allow for reducing the number of cell poles that are requires by multiple wireless providers in a common coverage area.

The foregoing description has been presented for purposes of illustration and description. Furthermore, the description is not intended to limit the inventions and/or aspects of the inventions to the forms disclosed herein. Consequently, variations and modifications commensurate with the above teachings, and skill and knowledge of the relevant art, are within the scope of the presented inventions. The embodiments described hereinabove are further intended to explain best modes known of practicing the inventions and to enable others skilled in the art to utilize the inventions in such, or other embodiments and with various modifications required by the particular application(s) or use(s) of the presented inventions. It is intended that the appended claims be construed to include alternative embodiments to the extent permitted by the prior art.

What is claimed is:

1. A modular cell pole, comprising:
a lower housing having a top surface, a bottom surface and a sidewall extending there between defining an interior space;
an upper housing having a top surface, a bottom surface and a sidewall extending there between defining an interior space, wherein the upper housing is supported by the lower housing;
a pole having an upper end, a lower end and a generally hollow interior, wherein the lower end of the pole is supported by the top surface of the upper housing; and
an antenna structure supported by the upper end of the pole.

2. The system of claim 1, wherein the lower housing and the upper housing each have a cross-dimension that is greater than a cross dimension of the lower end of the pole.

3. The system of claim 2, wherein the lower housing and the upper housing are generally cylindrical.

4. The system of claim 1, wherein the top surface of the lower housing and the bottom surface of the upper housing further comprise annular surfaces having open interiors, wherein the open interiors of the annular surfaces provide access between the interior spaces of the upper and lower housings.

5. The system of claim 1, wherein the antenna structure further comprises:
a first antenna; and
a second antenna.

6. The system of claim 5, further comprising:
first cell control equipment disposed within the interior space of the lower housing, wherein the first cell control equipment is operatively connected to the first antenna; and
second cell control equipment disposed within the interior space of the upper housing, wherein the second cell control equipment is operatively connected to the second antenna.

7. The system of claim 6, wherein a first cable extends between the first cell control equipment and the first antenna, wherein the first cable is routed through the interior space of the upper housing and through a hollow interior of the pole.

8. The system of claim 7, wherein a second cable extends between the second cell control equipment and the second antenna, wherein the second cable is routed through the hollow interior of the pole.

9. The system of claim 1, wherein the antenna support structure further comprises:
a first antenna support section configured to support a first antenna, wherein a lower end the first antenna support section is supported by the upper end of the pole; and
a second antenna support section configured to support a second antenna, wherein a lower end of the second antenna support section is supported by an upper end of the first antenna support structure.

10. The system of claim 9, further comprising:
a third antenna support structure configured to support a third antenna, wherein a lower end of the third antenna support structure

10. The system of claim 1, further comprising:
a mid-housing having a top surface, a bottom surface and a sidewall extending there between defining an interior space, wherein the mid-housing is disposed between the lower housing and the upper housing.

11. The system of claim 1, wherein the upper housing and the lower housing each further comprise:
at least one access opening extending through the sidewall; and
a door configured to selectively cover and expose the access opening.

12. A cell pole system, comprising:
a base housing having a top surface, a bottom surface and a sidewall extending there between defining an interior space;
first cell control equipment disposed within the interior space of the base housing;
an upper housing having a top surface, a bottom surface and a sidewall extending there between defining an interior space, wherein the upper housing is supported by the base housing;
second cell control equipment disposed within the interior space of the upper housing;
a pole having an upper end, a lower end and a generally hollow interior, wherein the lower end of the pole is supported by the top surface of the upper housing; and
an antenna structure supported by the upper end of the pole, the antenna structure having a first antenna and a second antenna;
wherein the first cell control equipment is operatively connected to the first antenna the second cell control equipment is operatively connected to the second antenna.

13. The system of claim 12, wherein a first cable extends between the first cell control equipment and the first antenna, wherein the first cable is routed through the interior space of the upper housing and through a hollow interior of the pole.

14. The system of claim 13, wherein a second cable extends between the second cell control equipment and the second antenna, wherein the second cable is routed through the hollow interior of the pole.
